(19) United States
(12) Patent Application Publication
(10) Pub. No.: US 2004/0010332 A1
(43) Pub. Date: Jan. 15, 2004

(54) System for delivering digital books

(76) Inventor: Tatsuo Nishizawa, Ueda-shi (JP)

Correspondence Address: BIRCH STEWART KOLASCH & BIRCH, PO BOX 747, FALLS CHURCH, VA, 22040-0747, US

(21) Appl. No.: 10/614,131

(22) Filed: Jul. 8, 2003

(30) Foreign Application Priority Data
Jul. 8, 2002 (JP) 2002-198507

(51) Int. Cl. G10L 21/00; G10L 11/00; G06F 7/00; G06F 17/00

(52) U.S. Cl. 700/94; 707/104.1; 704/270

(57) ABSTRACT

The delivery system of the present invention is capable of quickly and inexpensively delivering digital books. In the delivery system, a plurality of contents servers are connected to a network, the contents servers storing digital audio data of digital books. A data base server is connected to the network, and the data base server has a book data base storing search data of the digital books. A terminal equipment is connected to the network, and the terminal equipment includes: searching means for searching the search data of an object digital book; and playback means for communicating with the contents server including the digital audio data of the object digital book on the basis of the search data, downloading the digital audio data of the object digital book from the contents server and playing back the digital audio data as voice.

### BACKGROUND OF THE INVENTION

The present invention relates to a system for delivering digital books, more precisely relates to a system for delivering digital books, whose contents can be played back as voice by a terminal equipment, through a network.

Digital books have been provided for blind people. Contents of digital books are recorded in recording media as digital audio data. Digital audio data are recorded on the basis of recording standards, e.g., DAISY (Digital Accessible Information. System).

Conventionally, DAISY-standard digital books are provided as CDs (Compact Disks) and played back as voice. Therefore, blind people can enjoy books.

Unlike conventional audio books recorded in cassette tapes, chapters and pages of the digital books can be optionally searched, so the digital books are very useful media.

To purchase digital books recorded on CDs, etc., users must go to stores or order by mails.

Users would like to hear samples of digital books before purchase. However, in the case of mail order, it is difficult to hear samples before purchase.

Further, it is troublesome and dangerous for blind people to go to stores. Mail order is also troublesome.

Digital books recorded on CDs, etc. are expensive. Further, in the case of mail order, a package cost and a delivery cost are added, so that digital books are more expensive.

In the case of mail order, it takes several days to deliver digital books to purchasers. Namely, purchasers cannot get digital books soon.

### SUMMARY OF THE INVENTION

These days, data transmission speed through networks, e.g., internet, has been made higher, so that a large amount of data can be transmitted through networks.

Thus, the inventors of the present invention found that digital audio data of digital books can be delivered through networks.

An object of the present invention is to provide a delivery system for quickly and inexpensively delivering digital books.

Another object is to provide a delivery system capable of playing back samples of digital books.

The delivery system of the present invention comprises:

a plurality of contents servers being connected to a network, the contents servers storing digital audio data of digital books, which can be played back as voice;

a data base server being connected to the network, the data base server having a book data base storing search data of the digital books, which include addresses of the digital books in the contents servers and which can be searched on the basis of book information including names of authors and titles; and

a terminal equipment being connected to the network, the terminal equipment including: searching means for searching the search data of an object digital book on the basis of the book information thereof; and playback means for communicating with the contents server including the digital audio data of the object digital book on the basis of the search data searched by the searching means, downloading the digital audio data of the object digital book from the contents server and playing back the digital audio data as voice.

With this structure, a user can accesses the data base server connected to the network by the terminal equipment. An object digital book can be searched, in the data base server, on the basis of the book information thereof including a name of author and a title. The user can accesses to the contents server storing digital audio data of the object digital book on the basis of the results of the search. The digital audio data of the object digital book can be downloaded and played back as voice. Therefore, the user can quickly and easily get the object digital books.

In the system, the data base server is separated from the contents servers, so that load of each of the servers can be reduced. Since the search data excluding digital audio data are searched from the data base server, the search data can be quickly searched.

Further, a plurality of the contents servers are provided, so that load of each of the contents servers can be reduced.

In the system, the playing back means may plays back the digital audio data of the object digital book as voice with downloading the digital audio data of the object digital book. With this structure, the downloaded digital audio data can be played back without writing on a hard disk. Therefore, no hard disk for writing the downloaded digital audio data is required.

In the system, the network may be the internet, and the searching means may be a web browser software. In this case, the network and the software are ordinary means, so users can easily operate the system.

In the system, the terminal equipment may further include: log storing means for storing time of downloading digital audio data of digital books from the contents servers and the digital audio data downloaded as logs; and log transmission means for transmitting logs from the log storing means to the data base server on predetermined time interval, and

the data base server further has a log data base storing processed log data transmitted from the terminal equipment. With this structure, users can know download histories of digital books, e.g., number of times of downloading, through the data base server.

### BRIEF DESCRIPTION OF THE DRAWINGS

Embodiments of the present invention will now be described by way of examples and with reference to the accompanying drawings, in which:

FIG. 1 is a block diagram of the delivery system of the present invention;

FIG. 2 is a block diagram of a data base server;

FIG. 3 is a block diagram of a contents' server;

FIG. 4 is a block diagram of a terminal equipment;

FIG. 5 is a flow chart of action of the delivery system; and

FIG. 6 is a plan view of a keyboard of the terminal equipment.

### DETAILED DESCRIPTION OF THE EMBODIMENTS

Preferred embodiments of the present embodiments will now be described in detail with reference to the accompanying drawings.

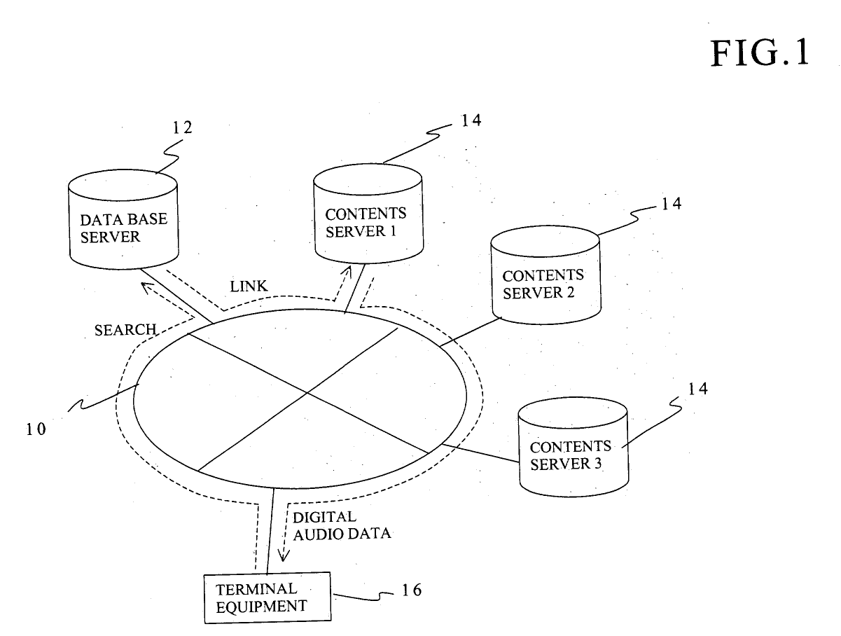

An outline of a digital book delivery system of the present embodiment will be explained with reference to FIG. 1.

The digital book delivery system comprises a data base server 12, a plurality of contents servers 14, and a terminal equipment 16. They are connected to the internet, which is an example of a network.

In the present embodiment, one terminal equipment 16 is shown, but number of the terminal equipments connected to the internet is not limited to one. Actually, a plurality of users may access by their terminal equipments.

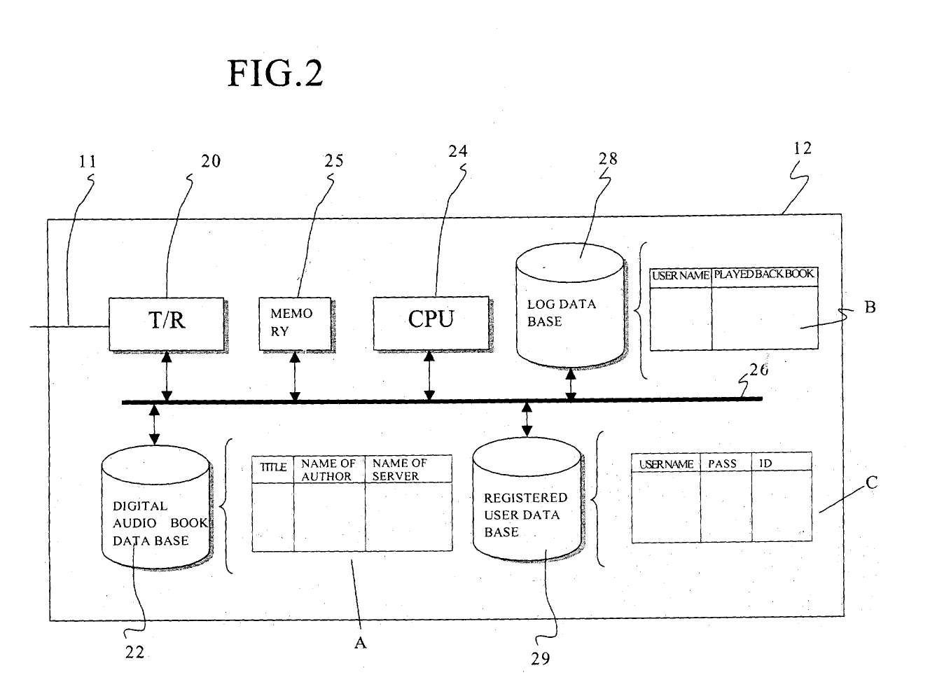

Successively, the servers 12 and 14 and the terminal equipment 16 will be explained. Firstly, the data base server 12 will be explained with reference to FIG. 2.

The data base server 12 comprises: a transmitting/receiving (T/R) section 20 connected to the internet 10 via a communication line 11; memory means 22 including a book data base “A”, which stores search data of digital books, which are link data including addresses of the digital books in the contents servers 14 and which can be searched on the basis of book information including names of authors, titles of the books, fields of the books, etc.; a central processing unit (CPU) 24 for controlling the whole data base server 12; and memory means 25, e.g., ROM, RAM, for storing control programs, information processed, etc. They are mutually connected via a bus 26.

The data base server 12 further has memory means 28 for storing a log data base “B”, which stores processed log data transmitted from the terminal equipments 16. The log data include time of playing back digital books, titles of digital books played back, etc. The log data are automatically transmitted from the terminal equipments 16 and received by the data base server 12 and stored in the memory means 28 as the log data base “B”.

The data base server 12 is capable of registering user data. In the present embodiment, users have been previously registered. User identifications (ID) and pass words are assigned to the registered users respectively. The user data are stored in memory means 29 as a user data base “C”.

The data base server 12 requests users, who access to an address of the data base server 12, to input their IDs and pass words through a web page. When IDs and pass words inputted coincides with registered data, the data base server 12 allows to use the digital book delivery system.

Note that, the memory means 22, 28 and 29 are, for example, hard disk units.

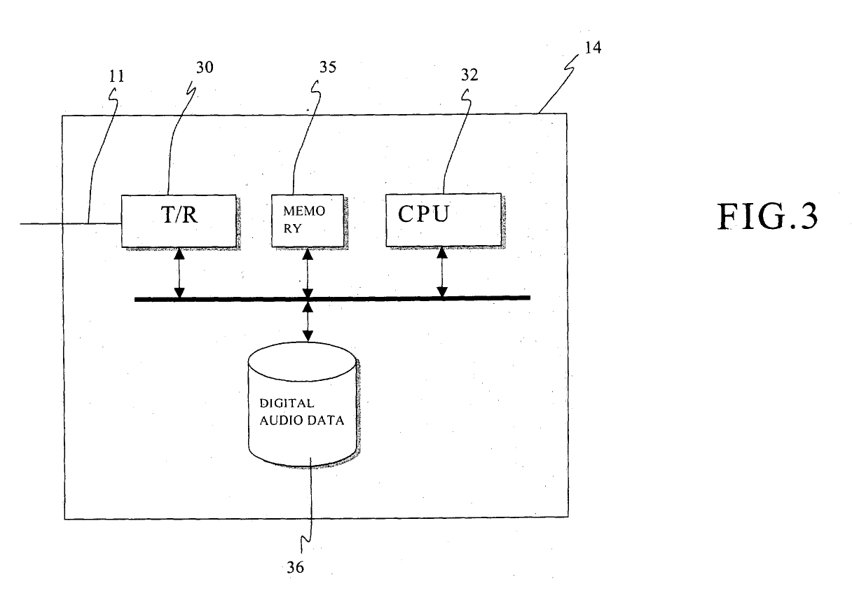

Next, the contents server 14 will be explained with reference to FIG. 3.

Each of the contents servers 14 comprises: a transmitting/receiving (T/R) section 30 connected to the internet 10 via the, communication line 11; memory means 36 storing digital audio data, which correspond to contents of books and which can be played back as voice; a central processing unit (CPU) 32 for controlling the whole contents server 14; and memory means 35, e.g., ROM, RAM, for storing control programs, information processed, etc. The memory means 36 is, for example, a hard disk unit.

As described above a plurality of the contents servers 14 are respectively connected to the internet 10. With this structure, concentrating data to one contents server 14 can be prevented, so that work load of each contents server 14 can be reduced. Further, the contents servers 14 are separately installed at different places, e.g., different cities, different states. By separately installing the contents servers 14, the system can be protected from accidents, disasters, etc.

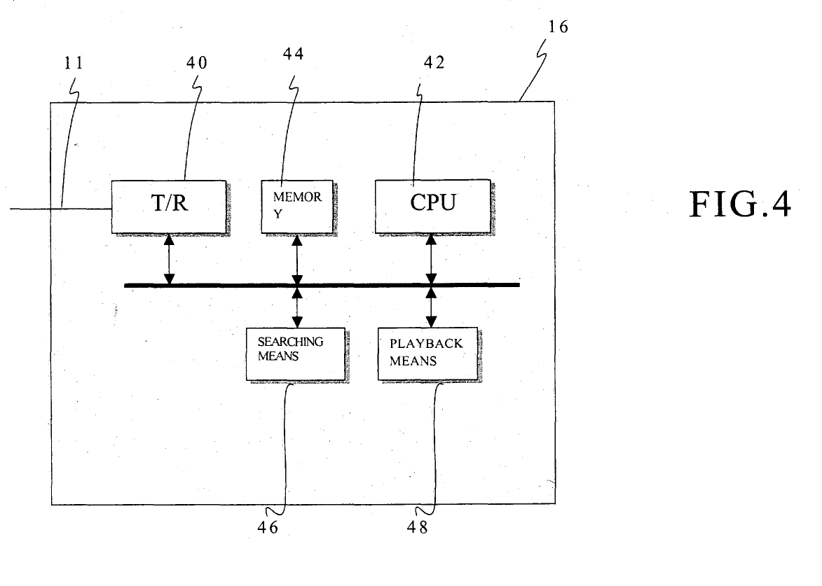

Next, the terminal equipment 16 will be explained with reference to FIG. 4.

Usually, the terminal equipments 16 are personal computers. Specific equipments for playing back digital books may be used as the terminal equipments. In the present embodiment, personal computers are used as the terminal equipments 16.

Each of the terminal equipments 16 comprises: a transmitting/receiving (T/R) section 40 connected to the internet 10 via the communication line 11; a central processing unit (CPU) 42 for controlling the whole terminal equipment 16; and memory means 44, e.g., ROM, RAM, for storing control programs, which controls the CPU 42, information processed, etc.

The terminal equipments 16 stores a plurality of application softwares for using the digital book delivery system.

The application softwares will be explained. For example, the soft wares are employed as searching means 46 and playback means 48 of the terminal equipment 16. The searching means 46 searches search data of an object digital book, from the data base “A” of the data base server 12, on the basis of the book information thereof. The playback means 48 communicates with the contents server 14 including the digital audio data of the object digital book on the basis of the search data searched by the searching means 46, downloads the digital audio data of the object digital book from the contents server 14 and plays back the digital audio data as voice. Note that, a web browser software stored in a hard disk (not shown) is, for example, used as the searching means 46.

Since the terminal equipments 16 are connected to the internet 10 and have the web browsers capable of browsing the web page of the data base server 12, users can search object digital books through the terminal equipments 16.

The playback means 48 for downloading and playing back digital audio data is a software stored in the hard disk (not shown).

The software for downloading and playing back digital audio data is an application software of a personal computer, and it is capable of playing back digital audio data as voice. The playback means 48 or the software plays back the digital audio data with downloading other digital audio data to be played back from the contents server 14. Namely, streaming playback can be executed. Further, in the present embodiment, the playback means 48 can once download digital audio data and play back downloaded data as voice. Namely, two ways of playback audio data can be selected. Note that, the playback means 48 or the software shows an operation picture on a screen of a display; users can play back the digital audio data with a mouse, a keyboard, etc.

The digital book delivery system will be mainly used by blind people. To easily operate the system, a known voice-input software for operating the web browser may be installed in the terminal equipment 16. By employing the voice-input software, object digital books can be searched by voice-inputting commands and data.

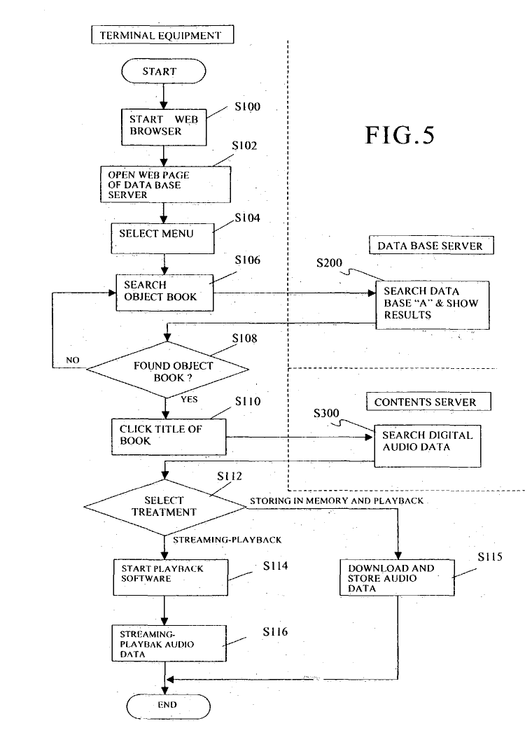

Successively, action of the digital book delivery system of the present embodiment will be explained with reference to a flow chart of FIG. 5. The flow chart of FIG. 5 includes not only action of the terminal equipment 16 but also that of the servers 12 and 14.

At a step S100, the user starts the web browser by the terminal equipment 16.

At a step S102, the web browser of the terminal equipment 16 opens the web page of the data base server 12. The terminal equipment 16 reads the web page and shows the web page on the display (not shown). Firstly, a picture for inputting a user ID and a password is shown. The user inputs his or her user ID and password.

If the user is allowed to enter the system at the step S102, the terminal equipment 16 is connected to a system guide so as to instruct the user to select menu. Note that, the menu includes, for example, “How to Use”, “Text Search”, “Best Ten Guide” and “New Book Information”.

At a step S104, the user selects one of the menu and clicks.

If the user selects “How to Use”, a text of how to use the digital book delivery system is shown on the display.

If the user selects “Text Search”, an object digital book can be searched on the basis of book information, e.g., a keyword, a name of an author and/or a category of the book. A title of the searched book or books are shown on the display and linked to the contents server or servers 14, in which the digital audio data of the searched book or books are stored.

If the user selects “Best Ten Guide”, the CPU 24 of the data base server 12 totalizes the log data of an assigned period, which is stored in the data base “B”, so as to show the best ten of the played back books. The titles of the best ten books are also linked to the contents server or servers 14, in which the digital audio data of the shown book or books are stored. By selecting “Best Ten Guide”, the user can know popular books and hear them soon.

If the user selects “New Book Information”, titles of newly stored digital books are shown on the display. The titles of the new books are also linked to the contents server or servers 14, in which the digital audio data of the shown book or books are stored.

At a step S106, if the user selects “Text Search” and search an object digital book, the data base server 12 searches the data base “A” on the basis of the book information, e.g., keyword. As the result of the search, the title of the searched book or books are shown on the display (step S200) and the search data (link data) thereof are searched.

At a step S108, if the object book is found in the searched books, the CPU 24 goes to a step S110. If the object book is not found, the CPU 24 returns to the step S1106 to retry.

At the step S110, the user clicks the title of the object book. The title of the book is linked to an object address of the object contents sever 14 on the basis of the search data. By clicking the title, the web browser connects to the linked contents server 14.

When the terminal equipment 16 is connected to the object contents server 14, the contents server 14 is capable of transmitting digital audio data of the object digital book to the terminal equipment 16. Upon clicking the title of the object book, the contents server 14 transmits the digital audio data of the object book to the terminal equipment 16.

At a step S112, the user selects treatment of the digital audio data: “Streaming-Playback” or “Storing in Memory”.

If the user selects “Storing in Memory”, the CPU 24 goes to a step S115. At the step S115, the object digital audio data are downloaded from the contents server 14 and stored in memory means, e.g., hard disk, of the terminal equipment 16. The stored data can be played back as voice at any time.

On the other hand, if the user selects “Streaming-Playback”, the CPU 24 goes to a step S114. At the step S114, the playback software 48. The playback software 48 plays back the digital audio data of the object digital book with downloading other digital audio data of the object digital book, which is transmitted from the contents server 14, at a step S116. Namely, the streaming-playback is executed.

Next, the playback software 48 will be explained.

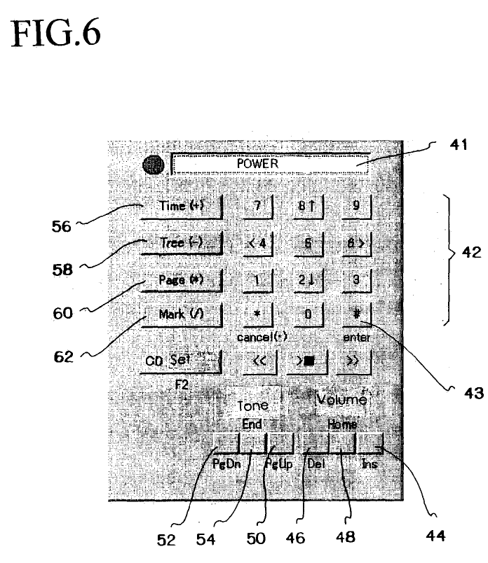

A keyboard of the terminal equipment 16, through which the playback software 48 is controlled, is shown in FIG. 6. Mouse is not a proper input device for blind people, so the keyboard is usually used.

By pushing a power switch 41, the playback software 48 is started or stopped.

“8” key of a ten key section 42 acts as “PLAY” key; “2” key thereof acts as “STOP” key. “6” key of the ten key section 42 acts as “FORWARDING” key; “4” key thereof acts as “BACKWARDING” key. By pushing the “6” or “4” key, a prescribed length of phrase or phrases are skipped forward or backward from the present playing back phrase. By continuously pushing the “6” key, it acts as “FAST-FORWARDING” key; by continuously pushing the “4” key, it acts as “FAST-BACKWARDING” key.

Volume of the played back voice can be adjusted by 10 levels. The volume is turned up by pushing “Ins” key 44; the volume is turned down by pushing “Del” key 46. By pushing the “Ins” key 44 or “Del” key 46, the volume is turned up or down one level.

Volume of voice of guidance is also adjusted, by 10 levels, with the “Ins” key 44 and the “Del” key 46. The voice of guidance and the played back voice of the digital audio data are switched by pushing “Home” key 48.

Playing back speed is adjusted by 10 levels. By pushing “PgUp” key 50, the playing back speed is made faster; by pushing “PgDn” key 52, the playing back speed is made slower. By pushing the “PgUp” key 50 or “PgDn” key 52, the playing back speed is changed one level.

Tone of the playing back voice is adjusted by 13 levels. By pushing the “PgUp” key 50, high-pitched tone is emphasized; by pushing the “PgDn” key 52, low-pitched tone is emphasized. By pushing the “PgUp” key 50 or “PgDn” key 52, the tone is changed one level. The playing back speed control and the tone control are switched by pushing “End” key 54.

Other functions of the keyboard will be explained.

Present time, total operation time, time elapsed and time rest are announced in order by voice by continuously pushing “Time(+)” key 56.

Number of a present index, an index of a present playing back part and total of indexes are announced in order by voice by continuously pushing “Time(−)” key 58. After the “Time(−)” key 58 is once pushed, if number of an object index is inputted and “enter” key 43 is pushed, the playback can be jumped to the object index.

Present page number, maximum page number and specific page number are announced in order by voice by continuously pushing “*” key 60. After the “*” key 60 is once pushed, if number of an object page is inputted and “enter” key 43 is pushed, the playback can be jumped to the object page.

“/” key 62 relates to bookmarkers. After the “/” key 62 is once pushed, if number of a bookmarker is inputted and “enter” key 43 is pushed, the playback can be jumped to the object bookmarker. After the “/” key 62 is pushed twice, if number of an object bookmarker is inputted and “enter” key 43 is pushed, the object bookmarker can be set. Further, after the “/” key 62 is pushed three times, if number of an object bookmarker is inputted and “enter” key 43 is pushed, the object bookmarker can be deleted.

In another embodiment, the keyboard may be shown on a display of the terminal equipment, and the keys shown may be operated by a mouse, a touch panel, a touch pad, etc.

In the above described embodiment, the network, to which the servers and the terminal equipments are connected, is the internet. But the network is not limited to the Internet, so the system of the present invention may be applied to a closed network for registered members.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A system for delivering digital books, comprising:
a plurality of contents servers being connected to a network, said contents servers storing digital audio data of digital books, which can be played back as voice;
a data base server being connected to the network, said data base server having a book data base storing search data of the digital books, which include addresses of the digital books in said contents servers and which can be searched on the basis of book information including names of authors and titles; and
a terminal equipment being connected to the network, said terminal equipment including: searching means for searching the search data of an object digital book on the basis of the book information thereof; and playback means for communicating with the contents server including the digital audio data of the object digital book on the basis of the search data searched by said searching means, downloading the digital audio data of the object digital book from the contents server and playing back the digital audio data as voice.

2. The system according to claim 1,
wherein said playback means plays back the digital audio data of the object digital book as voice with downloading the digital audio data of the object digital book.

3. The system according to claim 1,
wherein said network is the internet, and
said searching means is a web browser in a terminal equipment.

4. The system according to claim 1,
wherein said terminal equipment further includes: log storing means for storing time of downloading digital audio data of digital books from said contents servers and the digital audio data downloaded as logs; and log, transmission means for transmitting logs from said log storing means to said data base server on predetermined time interval, and
said data base server further has a log data base storing processed log data transmitted from said terminal equipment.
